(19) United States
(12) Patent Application Publication
(10) Pub. No.: US 2002/0033587 A1
(43) Pub. Date: Mar. 21, 2002

(54) Apparatus for attaching display item to vehicle

(76) Inventor: Scott McConnell, Martinez, CA (US)

Correspondence Address: Matthew J. Peirce, Esq., 1550 Starlight Canyon Avenue, Las Vegas, NV, 89123, US

(21) Appl. No.: 09/961,122

(22) Filed: Sep. 20, 2001

Related U.S. Application Data
(60) Provisional application No. 60/233,105, filed on Sep. 15, 2000.

(51) Int. Cl. B60D 1/01

(52) U.S. Cl. 280/504

(57) ABSTRACT

A new and improved apparatus is disclosed for attaching a display item to either an existing hitch box or to a hitch ball bolt, with the display item comprising a toy, light, character, sign, a fan, or other related item. The toys used with the present invention could vary widely and could easily be tied to seasonal holiday celebrations. Toys or signs could be lighted via an existing hitch electrical connection. The signs could vary widely in content, and could include the make and model of a vehicle, various sayings, names, catch phrases, and other types of sayings or slogans. Light-only attachments for collision avoidance or decorative purposes can be utilized with either an existing hitch box or to a hitch ball bolt and can also be lit via the existing hitch electrical connection.

### BACKGROUND OF THE INVENTION

The present invention concerns that of a new and improved apparatus for attaching a display item to either an existing hitch box or to a hitch ball bolt, with the display item comprising a toy, light, character, sign, a fan, or other related item.

### DESCRIPTION OF THE PRIOR ART

U.S. Pat. No. D409,537, issued to Adelaar, discloses an ornamental design of a soccer ball hitch cover.

U.S. Pat. No. D359,018, issued to Thigpen, discloses an ornamental design for a trailer ball hitch cover kit.

U.S. Pat. No. D358,794, issued to Thigpen, discloses an ornamental design for a trailer ball hitch cover kit.

U.S. Pat. No. 4,738,293, issued to Ostrom et al., discloses a decorative cover unit for the ball hitch of a towing vehicle to cover the ball when not in towing use.

### SUMMARY OF THE INVENTION

The present invention concerns that of a new and improved apparatus for attaching a display item to either an existing hitch box or to a hitch ball bolt, with the display item comprising a toy, light, character, sign, a fan, or other related item. The toys used with the present invention could vary widely and could easily be tied to seasonal holiday celebrations. Toys or signs could be lighted via an existing hitch electrical connection. The signs could vary widely in content, and could include the make and model of a vehicle, various sayings, names, catch phrases, and other types of sayings or slogans. Light-only attachments for collision avoidance or decorative purposes can be utilized with either an existing hitch box or to a hitch ball bolt and can also be lit via the existing hitch electrical connection.

There has thus been outlined, rather broadly, the more important features of a set of items that can be attached to a hitch box or a hitch ball bolt in order that the detailed description thereof that follows may be better understood and in order that the present contribution to the art may be better appreciated. There are, of course, additional features of the set of items that can be attached to a hitch box or a hitch ball bolt that will be described hereinafter and which will form the subject matter of the claims appended hereto.

In this respect, before explaining at least one embodiment of the set of items that can be attached to a hitch box or a hitch ball bolt in detail, it is to be understood that the set of items that can be attached to a hitch box or a hitch ball bolt is not limited in its application to the details of construction and to the arrangements of the components set forth in the following description or illustrated in the drawings. The set of items that can be attached to a hitch box or a hitch ball bolt is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present set of items that can be attached to a hitch box or a hitch ball bolt. It is important, therefore, that the claims be regard as including such equivalent constructions insofar as they do not depart from the spirit and scope of the present invention.

It is therefore an object of the present invention to provide a set of items that can be attached to a hitch box or a hitch ball bolt which has all of the advantages of the prior art and none of the disadvantages.

It is another object of the present invention to provide a set of items that can be attached to a hitch box or a hitch ball bolt which may be easily and efficiently manufactured and marketed.

It is another object of the present invention to provide a set of items that can be attached to a hitch box or a hitch ball bolt which is of durable and reliable construction.

It is yet another object of the present invention to provide a set of items that can be attached to a hitch box or a hitch ball bolt which is economically affordable and available to the buying public.

It is yet another object of the present invention to provide a set of items that can be attached to a hitch box or a hitch ball bolt which provides additional benefits not present in the prior art.

Other objects, features and advantages of the present invention will become more readily apparent from the following detailed description of the preferred embodiment when considered with the attached drawings and appended claims.

### BRIEF DESCRIPTION OF THE DRAWINGS

FIG. 1 shows the manner in which a hitch character of the present invention would be attached to a hitch box.

FIG. 2 shows various embodiments of a movable fan, with the movable fan representing a hitch toy of the present invention.

FIGS. 3 and 4 show the method of attachment for the present invention if the present invention would be attached to a standard hitch after the hitch ball had been removed.

FIG. 5 is a perspective view of some possible signs of the present invention that could be placed in lieu of a hitch.

### DESCRIPTION OF THE PREFERRED EMBODIMENT

FIG. 1 shows the manner in which a hitch character 2 of the present invention would be attached to a hitch box 4. Hitch character 2 would be connected to hitch box connector 6, which would be placed within hitch box 4. Once hitch box connector 6 has been placed entirely within hitch box 4, safety pin 8 would be used to removably secure hitch box 4 and hitch character 2 in a temporarily fixed position.

Hitch box 4 would be attached to the underside of the rear of a vehicle and would have a square cross-sectional shape. The end of hitch box 4 that would be sticking out and facing rearward would be open. Hitch box 4 would have four surfaces, a top side surface, a bottom side surface, a left side surface, and a right side surface. Hitch box 4 would have at least one pair of holes, with one hole from each pair located in the left side surface and the other hole from each pair of holes located in the right side surface. Each pair of holes would be used with safety pin 8 after hitch box connector 6 had been inserted into the open end of hitch box 4.

Hitch box connector 6 would also have a square cross-sectional shape and would be smaller than the inner diameter of the open end of hitch box 4. Hitch box connector 6 would have two ends, a first end and a second end, with the first end of hitch box connector 6 being insertable into hitch box 4. Hitch box connector 6 would have four surfaces, a top side surface, a bottom side surface, a left side surface, and a right side surface. Hitch box connector 6 would have at least one pair of holes, with one hole from each pair located in the left side surface and the other hole from each pair of holes located in the right side surface. Each pair of holes would be used with safety pin 8 after hitch box connector 6 had been inserted into the open end of hitch box 4. The second end of hitch box connector 6 would have hitch character 2 attached to it.

Instead of using hitch character 2, a sign, toy, light, fan, or other similar object could be used. Depending on which of these items would be used in lieu of a character 2, a user would need to make sure the hitch box connector 6 would be compatible with a particular hitch box 4 and safety pin 8 for a particular vehicle.

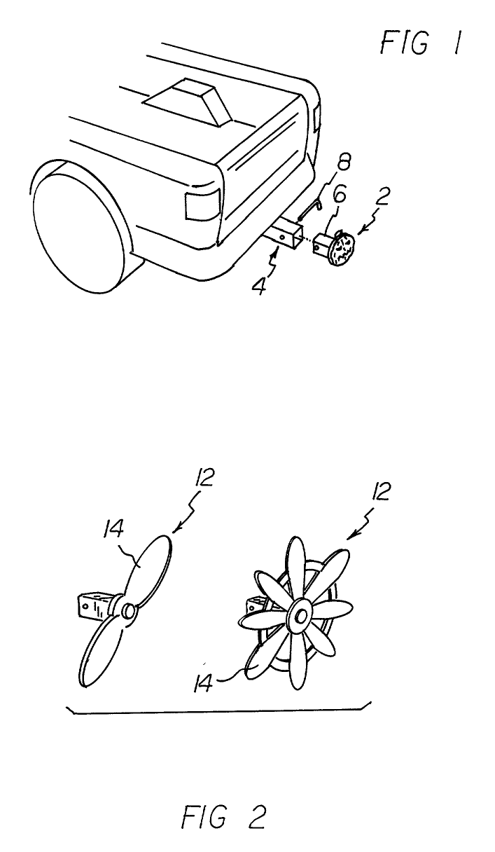

FIG. 2 shows various embodiments of a fan 14, with the fan 14 representing a specific item that could be placed on the second end of the hitch connector 6.

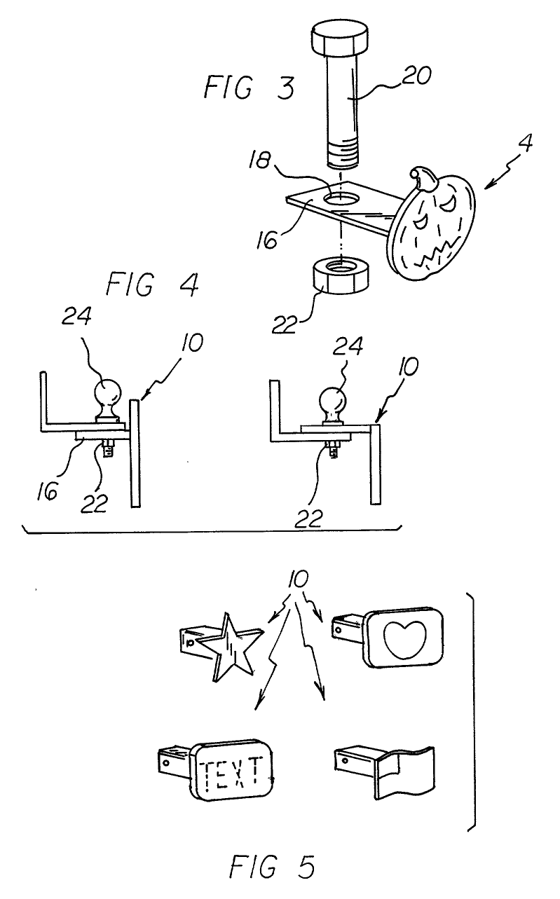

FIGS. 3 and 4 show the method of attachment for the present invention if the present invention would be attached to a standard hitch after the hitch ball had been removed. Generally, hitch character 4 (or hitch sign 10 or hitch toy 12) would be attached to a metal plate 16. The metal plate would be rectangularly shaped and would have two ends, a first end and a second end. The first end of the metal plate would be attached to the hitch character 4 (or hitch sign 10 or hitch toy 12). The second end of the metal plate would have a hole 18 located in it, with the hole capable of being placed over the hole where a hitch ball would have been removed on the back of a vehicle.

Next, screw 20 would be inserted through hole 18, with bolt 22 being screwed onto screw 20. In FIG. 4, screw 20 is not used, but rather, hitch ball 24 would be used. FIG. 4 shows a few various embodiments of how a hitch character 4 (or hitch sign 10 or hitch toy 12) could be attached to a hitch ball 24 and a bolt 22.

FIG. 5 is a perspective view of some possible signs of the present invention that could be connected to a hitch. These signs shown are not meant to be limiting, but are shown as possible representations of some of the themes that could be placed on hitch signs that would be used with the present invention, including lighting of the same via existing trailer lighting systems.

What I claim as my invention is:

1. An apparatus for attaching a display item to the rear of a vehicle comprising:
(a) a vehicle, the vehicle having a front side and a rear side,
(b) a hitch box fixedly attached to the rear side of the vehicle, the hitch box having a square cross-sectional shape, the hitch box having at least one open end, the hitch box positioned so that the open end would face rearward once the hitch box is attached to the rear side of a vehicle, the hitch box having four surfaces, a top side surface, a bottom side surface, a left side surface, and a right side surface, the hitch box having at least one pair of holes, with one hole from each pair located in the left side surface and the other hole from each pair of holes located in the right side surface,
(c) a hitch box connector, the hitch box connector having a square cross-sectional shape, the diameter of the hitch box connector being smaller than the inner diameter of the open end of the hitch box, the hitch box connector having two ends, a first end and a second end, the hitch box connector having four surfaces, a top side surface, a bottom side surface, a left side surface, and a right side surface, the hitch box connector having at least one pair of holes, with one hole from each pair located in the left side surface and the other hole from each pair of holes located in the right side surface,
(d) a display item attached to the second end of the hitch box connector,
(e) a safety pin for securing the hitch box connector to the hitch box,
(f) wherein a user would insert the first end of the hitch box connector into the hitch box, and further wherein the user would insert the safety pin through a pair of holes on the hitch box and a pair of holes on the hitch box connector.

2. An apparatus for attaching a display item to the rear of a vehicle according to claim 1 wherein the display item would be a character.

3. An apparatus for attaching a display item to the rear of a vehicle according to claim 1 wherein the display item would be a sign.

4. An apparatus for attaching a display item to the rear of a vehicle according to claim 1 wherein the display item would be a toy.

5. An apparatus for attaching a display item to the rear of a vehicle according to claim 1 wherein the display item would be a light.

6. An apparatus for attaching a display item to the rear of a vehicle according to claim 1 wherein the display item would be a fan.

7. An apparatus for attaching a display item to the rear of a vehicle comprising:
(a) a vehicle, the vehicle having a front side and a rear side,
(b) a hitch attachment having two ends, a first end and a second end, the first end of the hitch attachment being fixedly attached to the rear side of the vehicle, the second end of the hitch attachment having a hole, the hitch box having two surfaces, an upper surface and a lower surface,
(c) a metal plate having two ends, a first end and a second end, the first end of the metal plate having a hole, the metal plate having two surfaces, an upper surface and a lower surface,
(d) a display item attached to the second end of the metal plate,
(e) a safety pin for securing the hitch box connector to the hitch box, and
(f) means for removably attaching the first end of the metal plate to the second end of the hitch attachment.

8. An apparatus for attaching a display item to the rear of a vehicle according to claim 7 wherein the means for removably attaching the first end of the metal plate to the second end of the hitch attachment comprise:
(a) a screw having two ends, a first end and a second end, the first end of the screw being threaded,
(b) a bolt,
(c) wherein the first end of the screw would be inserted through the hole on the second end of the hitch attachment and the hole on the first end o the metal plate, and further wherein the bolt would be threadably attached to the first end of the screw.

9. An apparatus for attaching a display item to the rear of a vehicle according to claim 7 wherein the means for removably attaching the first end of the metal plate to the second end of the hitch attachment comprise:
(a) a hitch ball having two ends, a first end and a second end, the first end of the screw being threaded, the second end of the hitch ball having a metal ball,
(b) a bolt,
(c) wherein the first end of the hitch ball would be inserted through the hole on the second end of the hitch attachment and the hole on the first end of the metal plate, and further wherein the bolt would be threadably attached to the first end of the screw.

10. An apparatus for attaching a display item to the rear of a vehicle according to claim 7 wherein the display item would be a character.

11. An apparatus for attaching a display item to the rear of a vehicle according to claim 7 wherein the display item would be a sign.

12. An apparatus for attaching a display item to the rear of a vehicle according to claim 7 wherein the display item would be a toy.

13. An apparatus for attaching a display item to the rear of a vehicle according to claim 7 wherein the display item would be a light.

14. An apparatus for attaching a display item to the rear of a vehicle according to claim 7 wherein the display item would be a fan.
